(19) United States
(12) Patent Application Publication
(10) Pub. No.: US 2007/0157597 A1
(43) Pub. Date: Jul. 12, 2007

(54) Aircraft engine

(76) Inventor: John Sharp, Bude (GB)

Correspondence Address: FASSE PATENT ATTORNEYS, P.A., P.O. BOX 726, HAMPDEN, ME, 04444-0726, US

(21) Appl. No.: 10/587,346

(22) PCT Filed: Apr. 23, 2005
(86) PCT No.: PCT/DE05/00750

§ 371 Date: Jul. 25, 2006

(30) Foreign Application Priority Data
May 13, 2004 (DE) 10 2004 023 569.4

(51) Int. Cl. F02K 3/02

(52) U.S. Cl. 60/226.1; 60/802

(57) ABSTRACT

The invention relates to an aircraft engine, particularly a gas turbine engine. The aircraft engine comprises at least one fan (11) and a core engine (12). The fan (11) comprises a fan housing (13) which encloses a fan flow channel and at least one fan wheel (15). The core engine (12) comprises at least one compressor (15, 16), at least one combustion chamber (17) and at least one turbine (18, 19). The aircraft engine further comprises at least one generator (24) for producing electrical energy whereby the or each generator (24) produces electrical energy by withdrawing shaft power from the core engine (12). According to the invention the or each generator (24) for producing electrical energy is integrated into at least one strut (21) extending in the radial direction of the fan flow channel and is thus positioned within the fan flow channel.

The invention relates to an aircraft engine particularly a gas turbine engine according to the preamble of patent claim 1.

Engines for aircraft, be it engines for commercial aircraft or engines for military aircraft, produce in addition to the forward thrust for the movement of the aircraft, also energy for supply to attachment devices or auxiliary aggregates of the gas turbine or for the supply of systems carried by the aircraft such as the air conditioning system. The attachment devices, auxiliary aggregates of an aircraft engine or systems carried by the aircraft may comprise hydraulically, pneumatically, electrically or electromotor-driven devices, aggregates or systems.

In the development of aircraft a clear trend can be recognized to the effect that ever increasing electrical energy is needed in the aircraft. On the one hand this is due to the fact that hydraulically or pneumatically driven aircraft systems (for example the air conditioning system or actuators) are being replaced by electromotor-driven systems, and that on the other hand an ever increasing energy requirement is necessary per passenger seat in the aircraft. The aircraft engines thus must provide an ever increasing electrical power or an ever increasing electrical energy. Such aircraft engines are also referred to as “more electric engine” (MEE).

For producing electrical energy for supply to the attachment devices or auxiliary aggregates of the gas turbine as well as to the systems carried by the aircraft, it is already known in the prior art to withdraw from a core engine of the gas turbine mechanical energy which, for example, is used for driving pumps and generators. The German Patent Publication DE 41 31 713 C2 shows an aircraft engine wherein shaft power is taken-off the core engine and this shaft power is supplied to auxiliary aggregates.

According to the prior art, the shaft power taken off the core engine of an aircraft engine is used either for directly driving pneumatic or hydraulic devices, aggregates or a system of an aircraft or the taken-off shaft power is converted into electrical energy. Generators serve for converting the mechanical shaft power taken from the core engine, into electrical energy. These generators are conventionally integrated into the core engine. Generators integrated into the core engine are exposed to extreme operating conditions, for example very high temperatures. Thus, according to the prior art expensive measures are required for cooling the generators. Thereby, the costs for the aircraft engine are increased.

Starting from the foregoing the underlying problem of the invention is to produce a new aircraft engine.

This problem has been solved in an aircraft engine according to patent claim 1. According to the invention the or each generator for producing electrical energy is integrated into at least one strut extending in a radial direction of the fan flow channel and is thus positioned within the fan flow channel.

In accordance with the present invention it is suggested that the generators for producing electrical energy are integrated into struts that extend in a radial direction of the fan flow channel. Thus, the generators are not integrated into the core engine of the aircraft engine, rather they are positioned outside thereof in the fan flow channel. The generators are thereby exposed to relatively clean and moderate operating conditions so that expensive cooling mechanisms for cooling the generators are obviated. Furthermore, in an aircraft engine constructed according to the invention, the generators for producing electrical energy are easily accessible and thus easily demountable from the aircraft engine for maintenance work.

According to an advantageous further embodiment of the invention the or each generator is coolable by an air stream flowing through the fan flow channel. For this purpose openings are integrated into each strut in which the or each generator is integrated in order to pass by a portion of the airstream flowing through the fan flow channel, past the or each generator for cooling.

Preferred further embodiments of the invention are provided by the dependent claims and the following description. An example embodiment of the invention will be explained in detail without being limited thereto. Thereby shows:

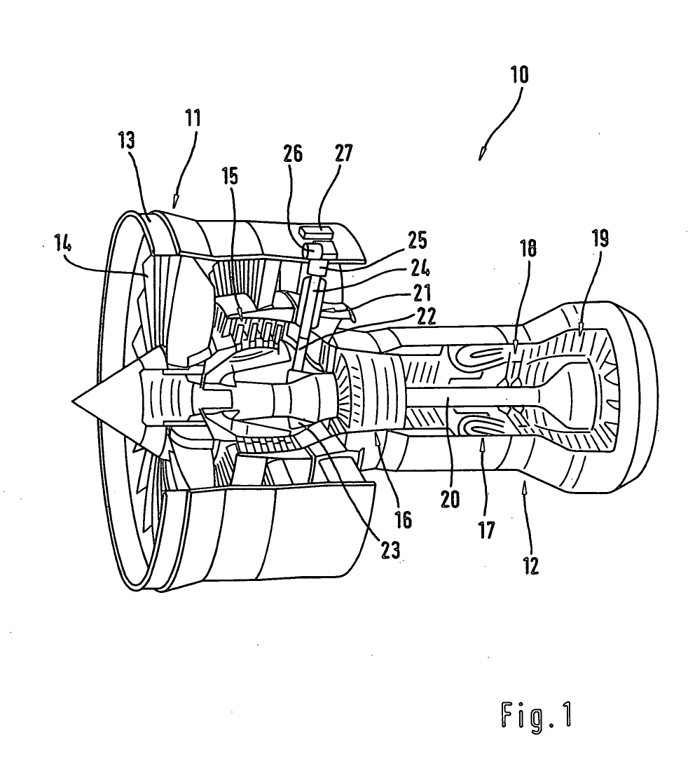

FIG. 1 a schematic illustration of an aircraft engine according to the invention.

With reference to FIG. 1 the gas turbine according to the invention will be described in larger detail as follows.

FIG. 1 shows a schematic cross-section through an aircraft engine 10 according to the invention whereby the aircraft engine 10 of FIG. 1 comprises a fan 11 as well as a core engine 12. The fan 11 comprises a fan housing 13 whereby the fan housing 13 encloses a fan flow channel. Furthermore, the fan 11 comprises at least one fan wheel 14. The fan 11 represents a low pressure compressor.

The core engine 12 comprises at least one compressor, at least one combustion chamber and at least one turbine. In the shown example embodiment the core engine 12 comprises two compressors namely a medium pressure compressor 15 and a high pressure compressor 16. Downstream of the high pressure compressor 16 follows a combustion chamber 17. Downstream of the combustion chamber 17 there are positioned a high pressure turbine 18 and a low pressure turbine 19 of the core engine 12.

FIG. 1 further shows a shaft 20 passing through the core engine 12. Mechanical shaft power can be taken off the shaft 20 of the core engine 12 for producing electrical energy. The mechanical shaft power which is taken off the core engine 12 is supplied at least to one generator for producing electrical energy.

According to the present invention, the or each generator for producing electrical energy from the shaft power taken off the core engine 12, is integrated into a strut extending in the radial direction of the fan flow channel. Thus, the or each generator is positioned within the fan flow channel.

FIG. 1 shows substantially schematized, a strut 21 extending in the radial direction of the fan flow channel. A drive shaft 22 is led through the strut 21. Mechanical shaft power can be taken-off the shaft 20 of the core engine 12 with the aid of the drive shaft 22. This drive shaft 22 is coupled at the radially inner end of the fan flow channel and thus at the radially inwardly positioned end of the strut 21, through a first gear box 23 with the shaft 20 of the core engine 12. This gear box 23 is preferably constructed as a rotation speed increasing gear box in order to convert the rotational speed of the shaft 20 of the core engine 12 into a rotational speed that is compatible with the generator. The rotational speed increasing gear box is constructed particularly as an epicyclic gear box and is also referred to as a “transfer gear box”.

In accordance with the present invention, a generator 24 for producing electrical energy shown schematically in FIG. 1 is integrated into the strut 21. Thus, the generator 24 is arranged within the fan flow channel where it is exposed merely to relatively low temperatures. Openings may be integrated into the strut 21 for cooling the generator 24. Thus, a portion of the air stream flowing through the fan flow channel is moved past the generator 24 for cooling the same.

The generator 24 integrated into the strut 21 is shown to be coupled, in the illustrated example embodiment, at the radially outer end of the fan flow channel or of the strut 21 through a second gear box 25 with attachment devices 26 and 27 of the aircraft engine. The second gear box 25 is also referred to as “accessory drive gear box”. The attachment device 26 is embodied, for example, by a hydraulic system of the aircraft engine. The attachment device 27 is embodied, for example, by an electrically operated closed loop control device or an open loop control device.

According to the present invention, electrical or electronic structural components for the closed loop power control are also integrated into the strut 21 in addition to the generator 24.

According to the present invention, the strut 21 together with the generator 24 integrated into the strut 21 and the power electronics, possibly also integrated into the strut 21, are demountable as a unit out of the fan flow channel. Hereby it is assured that this unit is easily accessible for maintenance work. In order to perform maintenance work on the generator 24 and on the respective power electronics it is thus not necessary to perform any work on the aircraft engine as such.

The generator 24 integrated into the strut 21 comprises at least one stator and at least one rotor. The or each stator of the generator is thereby integrated into the strut 21 in a stationary position. The or each rotor of the generator is integrated into the strut 21 in such a way that a rotation relative to the or each stator of the generator 24 is possible. As mentioned, the generator 24 is coupled through the first gear box 23 with the shaft 20 of the core engine 12. Particularly the drive shaft 22 is coupled with the shaft 12 of the core engine 12 and drives the or each rotor of the generator 24.

The generator 24 or the strut 21 in which the generator 24 is integrated, are coupled through suitable bearings particularly with the shaft 20 of the core engine 12. In the same way bearings are integrated into the strut 21 for the generator 24. Furthermore, at the radially outwardly positioned end of the strut 21 a suitable bearing is provided for coupling to the attachment devices 26 and 27. The bearings may for example be constructed as ceramic bearings.

The current provided by the generator 24 depends in principle on the rotational speed of the shaft 20 of the core engine 12. In order to provide a d.c. current independent of the rotational speed of the shaft 20, a respective power electronic is integrated into the strut 21. With the aid of this power electronic it is possible, independently of the rotational speed of the shaft 20 of the core engine 12, to provide a starting d.c. voltage of about 270 volts. The generator 24 is dimensioned in accordance with the present invention in such a way that the generator can provide an electrical output value in the range of 100 to 250 kVA.

The generator integrated into the strut 21 can also be operated, in accordance with the present invention, as a motor for starting the aircraft engine.

Although FIG. 1 shows only one strut 21 with one generator 24 integrated therein, in accordance with the invention several struts may be extending in the area of the fan flow channel with generators integrated therein.

The generators integrated into the struts and the corresponding electronic or power electronic may be constructed as multi-stage or modular units. In this case a “stack” of several generators with the corresponding electronics is integrated into the struts. In this way it is possible to provide the electrical power for a multitude of different aircraft engines with small costs for the respective required electrical power. Furthermore, advantages are obtained for the maintenance work of the aircraft engines. It is merely necessary to hold ready a small number of the same modules for the maintenance work.

Concluding, it should be mentioned that the or each strut in which generators for producing electrical energy are integrated, have a rather large dimension in the radial direction of the fan flow channel, however, in the axial direction as well as in the circumferential direction of the fan flow channel they have a small dimension. Thus, the struts with the generators integrated therein have a large ratio of length to diameter. Hereby it is assured that the airflow through the fan flow channel is hardly impaired at all.

1. An aircraft engine, particularly a gas turbine engine, with at least one fan (11) and a core engine (12), whereby the fan (11) comprises a fan housing (13) enclosing a fan flow channel, and at least one fan wheel (15), and whereby the core engine (12) comprises at least one compressor (15, 16), at least one combustion chamber (17), and at least one turbine (18, 19), and with at least one generator (24) for producing electrical energy, whereby the or each generator (24) produces electrical energy by withdrawing shaft power from the core engine (12), characterized in that the or each generator (24), for producing electrical energy, is integrated into at least one strut (21) extending in a radial direction of the fan flow channel, and thus is positioned within the fan flow channel.

2. The aircraft engine of claim 1, characterized in that the or each generator (24) or the or each strut (21) into which the or each generator (24) is integrated, is demountable out of the fan flow channel for maintenance work.

3-9. (canceled)

10. The aircraft engine of claim 1, characterized in that the or each generator (24) is coolable by an air flow flowing through the fan flow channel, whereby for this purpose openings are integrated into the or each strut (21) into which the or each generator (24) is integrated, in order to move a portion of the air flow flowing through the fan flow channel past the or each generator (24) for cooling.

11. The aircraft engine of claim 1, characterized in that each generator (24) comprises at least one stator and at least one rotor, whereby the or each generator, particularly the rotor thereof, is coupled at a radially inwardly positioned end through a first gear box (23) with the shaft (20) of the core engine (12), from which shaft power is taken-off.

12. The aircraft engine of claim 11, characterized in that the or each stator is positioned in a fixed location within the respective strut (21), and in that the or each rotor rotates within the respective strut (21) relative to the or each stator.

13. The aircraft engine of claim 11, characterized in that the first gear box (23), through which the or each generator (24) is coupled to the shaft (20) of the core engine (12), is constructed as a rotational speed increasing gear box.

14. The aircraft engine of claim 1, characterized in that the or each generator (24) is coupled, at a radial outward end of the fan flow channel, through a second gear box (25) with pneumatically and/or hydraulically operated attachment devices (26) of the aircraft engine.

15. The aircraft engine of claim 1, characterized in that in addition to the or each generator (24) also electronic assemblies for the closed loop power control of the or each generator (24), are integrated into the respective strut (21).

16. The aircraft engine of claim 1, characterized in that the or each generator (24) can also be used in a motor operation for starting the aircraft engine.

17. The aircraft engine of claim 12, characterized in that the first gear box (23), through which the or each generator (24) is coupled to the shaft (20) of the core engine (12), is constructed as a rotational speed increasing gear box.
